(19) United States
(12) Patent Application Publication
(10) Pub. No.: US 2016/0182220 A1
(43) Pub. Date: Jun. 23, 2016

(54) ENCODING DATA USING DYNAMIC SYSTEM COUPLING

(71) Applicant: LANCASTER UNIVERSITY BUSINESS ENTERPRISES LIMITED, Lancashire (GB)

(72) Inventors: Tomislav Stankovski, Lancashire (GB); Aneta Stefanovska, Lancashire (GB); Robert James Young, Lancashire (GB); Peter Vaughan Elsmere McClintock, Lancashire (GB)

(73) Assignee: Lancaster University Business Enterprises Limited, Lancashire (GB)

(21) Appl. No.: 14/910,547

(22) PCT Filed: Jul. 24, 2014
(86) PCT No.: PCT/GB2014/052260

§ 371 Date: Feb. 5, 2016

(30) Foreign Application Priority Data
Aug. 7, 2013 (GB) 1314114.8

(51) Int. Cl. H04L 9/00; G06F 21/78

(52) U.S. Cl. CPC H04L 9/001; G06F 21/78

(57) ABSTRACT

A method of encoding data at a computer, the computer storing data associated with a plurality of dynamical subsystems, each dynamical subsystem having a plurality of associated state variables, the plurality of dynamical subsystems being coupled by a plurality of coupling functions. The method comprises receiving, at the computer, data to be encoded; inputting, at the computer, the data to be encoded into the plurality of dynamical subsystems as a plurality of parameters of the coupling functions; and outputting, from the computer, a plurality of state variables associated with the plurality of dynamical subsystems, the plurality of state variables comprising at least one of the plurality of state variables associated with each of the dynamical subsystems, the plurality of state variables providing an encoding of the received data.

The present invention relates to systems and methods for encoding and decoding data using coupled dynamical systems.

The use of computers has become widespread in almost every aspect of life. The widespread use of the Internet allows computers to easily be connected to each other and data to easily be transferred between connected computers.

Data encryption is often used to protect sensitive information by transforming data into an encrypted form to make the data unreadable without appropriate knowledge of how the data can be decrypted. By encrypting data before transferring the data therefore, the data can be securely transferred.

Many encryption methods are known. In general, the security of an encryption method depends upon how unpredictable the output of the encryption method is. The unpredictability of an encryption method directly affects security of the encrypted data, that is how difficult it is for a malicious third party to decrypt the data. In general, encryption methods that incorporate greater unpredictability provide greater security.

Dynamical systems are systems that are defined by a set of state variables and the time dependence of the state variables follows a fixed, deterministic rule. Examples of dynamical systems include oscillators such as pendulums and the flow of water in a pipe. Many dynamical systems are chaotic such that the system responds to small changes to the system in an unpredictable way and their use in encryption has therefore been contemplated. For example, U.S. Pat. No. 5,291,555 discloses an encryption method in which data to be encrypted is input as a parameter to a chaotic system such as a Lorenz system.

In the disclosure of U.S. Pat. No. 5,291,555 one of the state parameters of a single chaotic system is modified by data to be encoded at an encoder and an output signal is transmitted to a receiver. The receiver includes the same chaotic system as the encoder and generates a corresponding output signal without modification by the data to be encoded. The output signal with modification by the data to be encoded and the output signal without modification are compared. The data to be encoded can be determined based upon the difference between the modified and unmodified output signal. However the encryption method of U.S. Pat. No. 5,291,555 has been shown in Perez, “Extracting Messages Masked by Chaos”, Physical Review Letters, Volume 74, Number 11, 13 Mar. 1995 to be susceptible to attack such that messages encoded using the encoding method can be intercepted and decoded by a malicious third party. There therefore remains a need for improved encoding methods.

According to an aspect of the invention there is provided a method of encoding data at a computer the computer including a plurality of dynamical subsystems, each dynamical subsystem having a plurality of associated state variables, the plurality of dynamical subsystems being coupled by a plurality of coupling functions. The method comprises receiving, at the computer, the data to be encoded; inputting the data to be encoded into the plurality of dynamical subsystems as a plurality of parameters of the coupling functions; and outputting a plurality of state variables associated with said plurality of dynamical subsystems, said plurality of state variables comprising at least one of said plurality of state variables associated with each of said dynamical subsystems, said plurality of state variables providing an encoding of said received data.

Whilst the coupling of systems using coupling functions is generally known, the inventors have realised that inputting data to be encoded into a plurality of dynamical systems as parameters of coupling functions that couple the dynamical systems and transmitting a state variable of the systems allows data to be encoded in a way that is resilient to attempts to decrypt the input data. However the inventors have realised that a decoder that is arranged based upon prior knowledge of the dynamical systems and the coupling functions can decrypt all of the encrypted input data based upon the plurality of state variables.

Coupling functions are generally functions that are present in a function of a first system having a first set of state variables and that include variables of a second set of state variables of a second system that is to be coupled to the first system. The coupling of the first system and the second system causes changes in one system to affect the other system and causes the changes in the systems to lead to complicated dynamical mixing and therefore to be more difficult to predict. At least one of the plurality of dynamical systems may be a self-sustaining oscillating system and/or a chaotic system. At least one of the plurality of dynamical systems may be a Lorenz system and at least one of the plurality of dynamical systems may be a Rossler system. For example, the plurality of dynamical systems may comprise a Lorenz system and a Rossler system that are coupled by a plurality of coupling functions.

The output plurality of state variables may comprise a single state variable for each dynamical subsystem. The inventors have realised that it is possible to decode data that is input to an encoder by a suitably arranged decoder based only on output state variables of the dynamical subsystems at the encoder. Without prior knowledge of the dynamical subsystems at the encoder decoding the output state variables is not possible such that the encoding method provides a highly secure method of encrypting data.

A first coupling function of the plurality of coupling functions may form a part of a first dynamical subsystem of the plurality of dynamical subsystems and the first coupling function may comprise at least one state variable of a second of the plurality of dynamical subsystems. In this way the dynamical subsystems are coupled by providing coupling functions that cause changes within one subsystem to affect the other subsystem, thereby increasing the interaction between the subsystems and causing the subsystems to exhibit less predictable behaviour. Such interaction increases the effectiveness of the encoding.

The method may further comprise processing the plurality of dynamical systems to determine time derivatives of each of the plurality of state variables associated with each of the plurality of dynamical subsystems. For example, the subsystems may be evaluated at a plurality of time points to determine values of state variables of the subsystems.

Outputting a plurality of state variables associated with the plurality of dynamical subsystems may comprise outputting a plurality of values for each of the output state variables. For example, a value of each of the output state variables may be output at each of a plurality of time points.

According to a further aspect of the invention there is provided a method of decoding data at a computer, the computer storing data associated with a plurality of dynamical subsystems, each dynamical subsystem having a plurality of associated state variables. The method comprises receiving, at the computer from an encoder, data associated with a plurality of encoder state variables, the encoder state variables being associated with a plurality of dynamical subsystems at the encoder used to encode said data to be decoded, the plurality of dynamical subsystems at the encoder being coupled by a plurality of coupling functions; inputting, at the computer, the plurality of encoder state variables as parameters of the plurality of dynamical subsystems to determine values for each of the plurality of state variables associated with the plurality of dynamical subsystems; and processing, by the computer, the determined values to generate the data to be decoded.

Processing the determined values to generate the data to be decoded may comprise performing dynamical Bayesian inference on the determined values. Performing dynamical Bayesian inference on the determined values may comprise iteratively processing the determined values based upon the plurality of dynamical subsystems.

For example, performing dynamical Bayesian inference on the determined values may comprise generating, at the computer, an Euler discretisation vector from the determined values; generating a midpoint time series vector from the determined values; and processing the Euler discretisation vector and the midpoint time series vector to generate the data to be decoded. Processing the Euler discretisation vector and the midpoint time series vector may comprise iteratively processing the Euler discretisation vector and the midpoint time series vector to determine an estimate of a parameterisation of each dynamical subsystem to generate said data to be decoded. The iterative processing may be repeated until a stopping condition is met, for example until the estimate of the parameterisation at consecutive iterations differ by less than a predetermined value.

The data associated with a plurality of dynamical subsystems may comprise data associated with the plurality of dynamical subsystems at the encoder. For example, the data stored associated with the plurality of dynamical subsystems at the decoder may be data that causes the dynamical subsystems at the decoder to be synchronized with the dynamical subsystems at the encoder. The data associated with a plurality of dynamical subsystems may further comprise data associated with the plurality of coupling functions at the encoder. The data to be decoded may be determined based upon the data associated with a plurality of dynamical subsystems at the encoder. The form of the dynamical subsystems at the encoder together with the form of the coupling functions at the encoder may therefore be used to generate the data to be decoded by processing the values determined for each of the plurality of state variables associated with the plurality of dynamical subsystems.

The received data associated with a plurality of encoder state variables may be associated with values of the encoder state variables at a plurality of time points. For example, a block of data may be received for decoding and the block of data may be processed to decode the data that is encoded.

At least one of the plurality of dynamical systems may be a self-sustaining oscillating system and/or a chaotic system. For example, at least one of the plurality of dynamical systems is system selected from the group consisting of: a Lorenz system; and a Rossler system.

The data associated with a plurality of encoder state variables may comprise a single state variable for each dynamical subsystem at the encoder at each of a plurality of time points.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention or as an embedded system such as using an FPGA.

Embodiments of the invention will now be described with reference to the accompanying Figures in which:

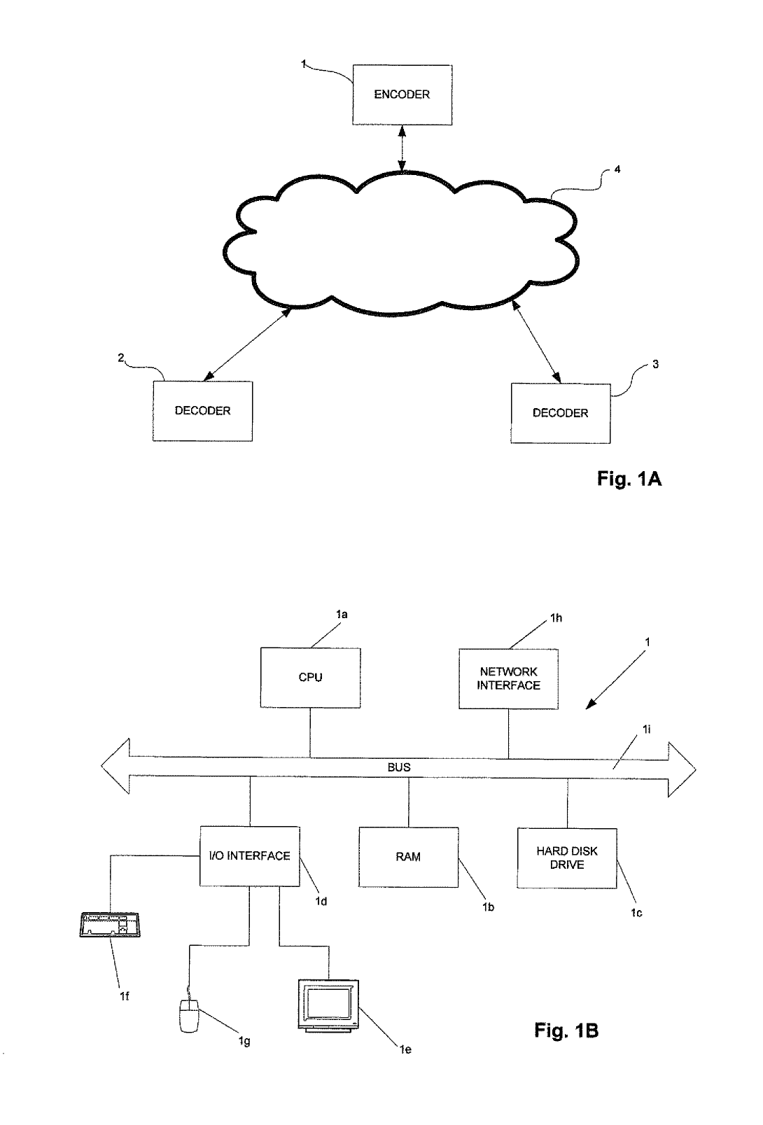

FIG. 1A is schematic illustration of a network of computers suitable for carrying out the invention;

FIG. 1B is schematic illustration of a computer of the network of computers of FIG. 1;

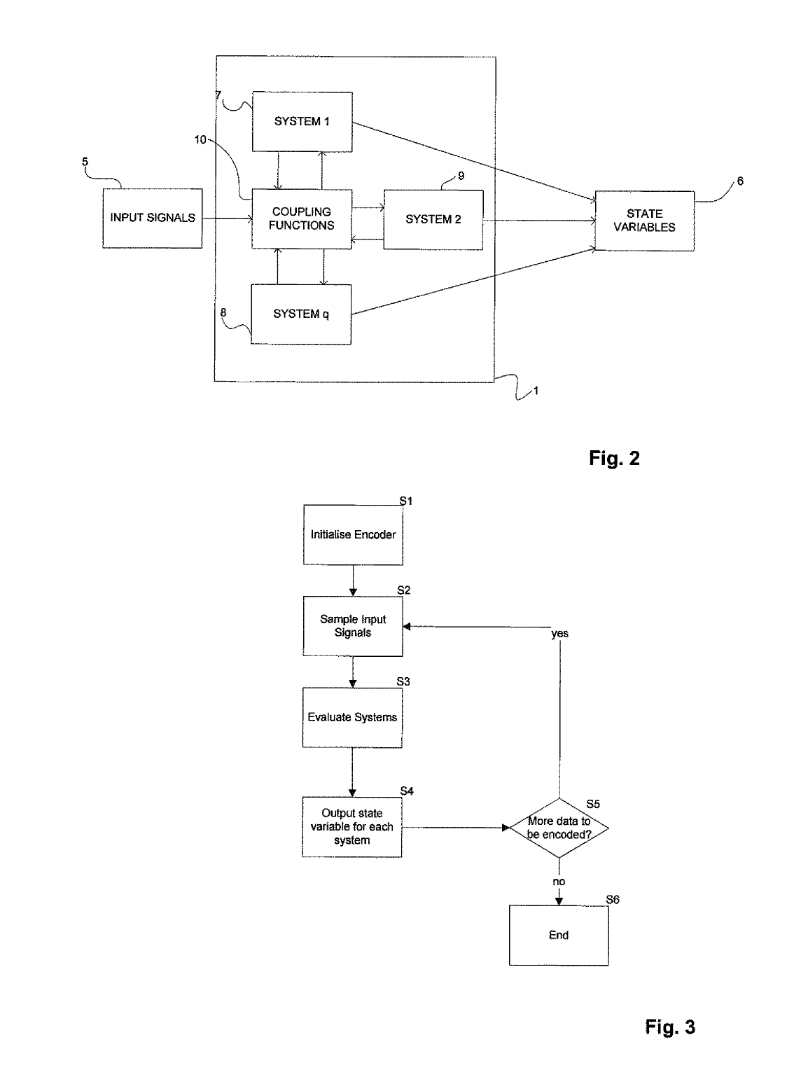

FIG. 2 is a schematic illustration of an encoding process at an encoder;

FIG. 3 is a flowchart showing encoding of data at an encoder;

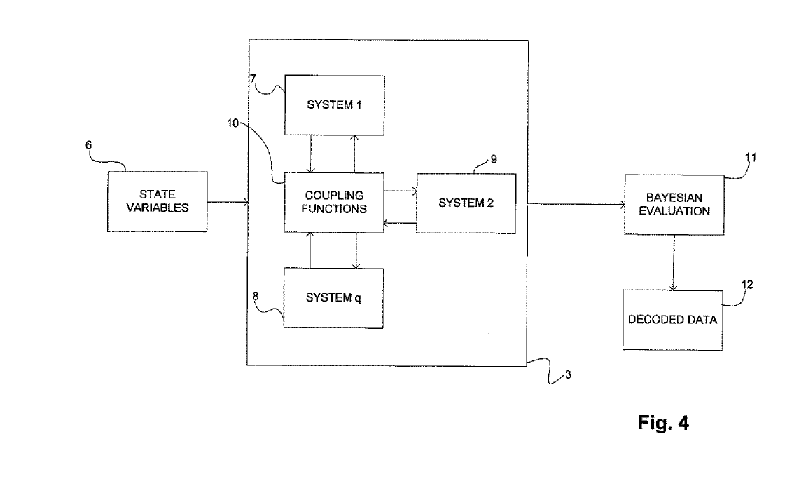

FIG. 4 is a schematic illustration of a decoding process at a decoder;

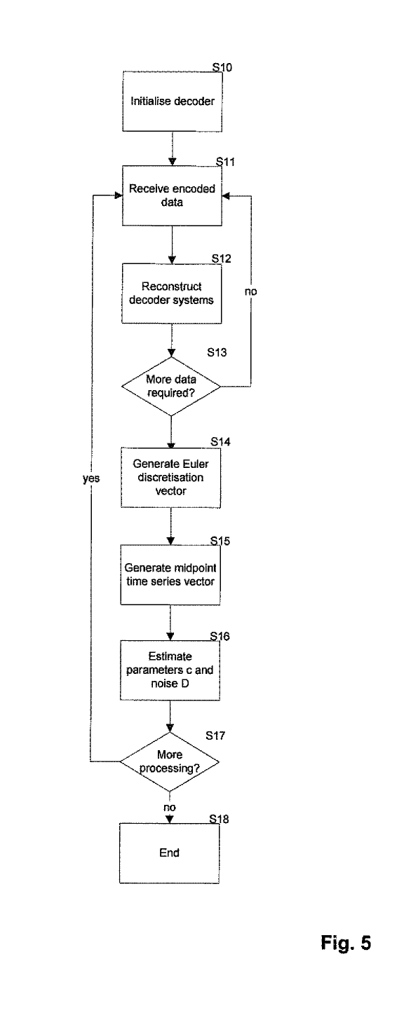

FIG. 5 is a flowchart showing decoding of data at a decoder;

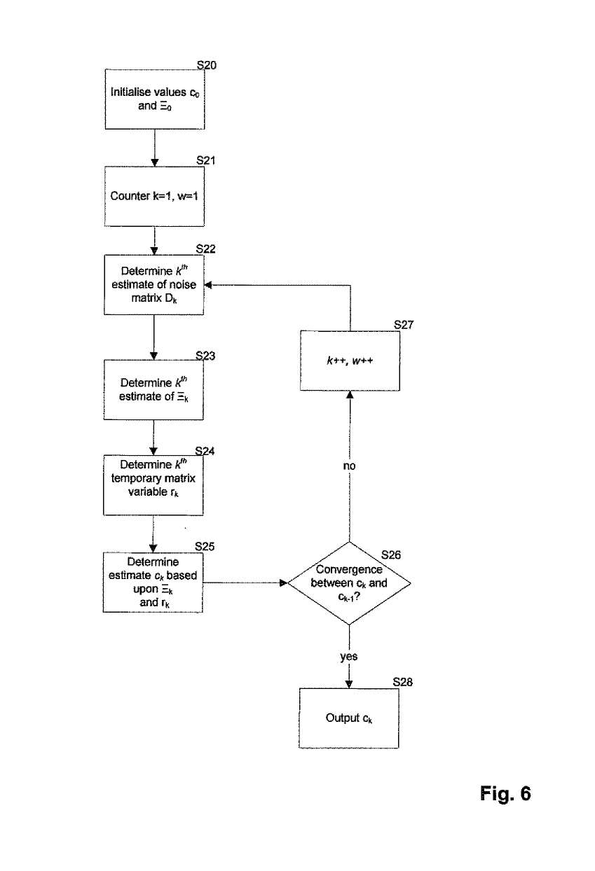

FIG. 6 is a flowchart showing part of the processing of FIG. 5 in further detail;

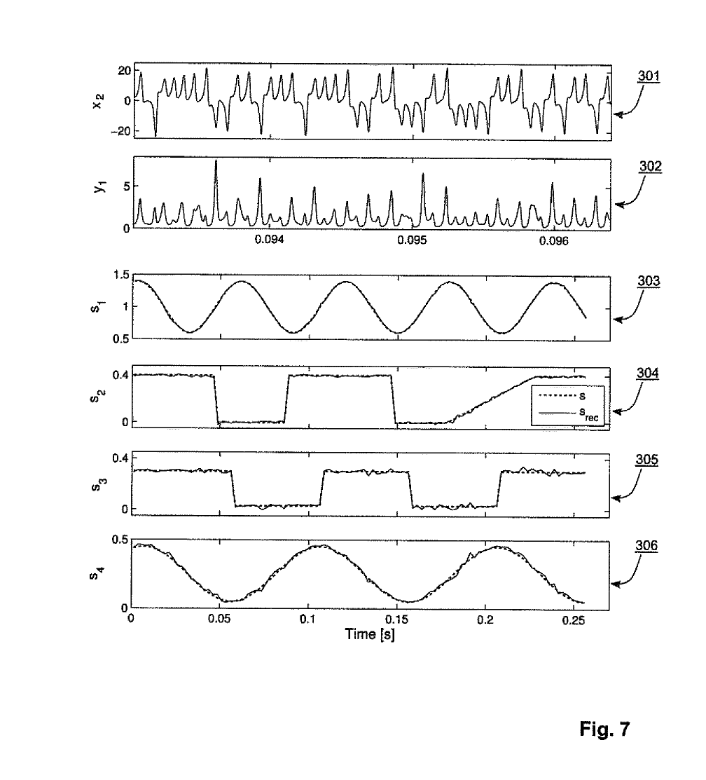

FIG. 7 shows data generated by an example encoder and decoder; and

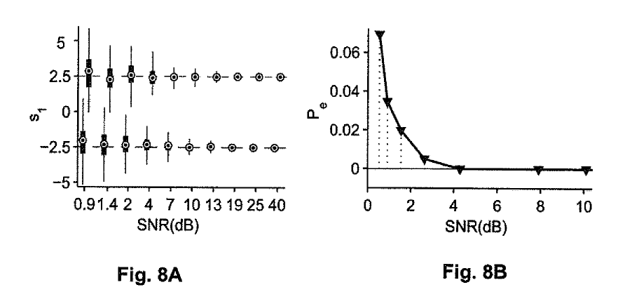

FIG. 8A shows an example of the effect of noise in a transmission on data received at a decoder; and

FIG. 8B shows a graph illustrating the probability of a bit being decoded erroneously.

Referring first to FIG. 1A, a network of computers suitable for carrying out the invention is shown. The network of computers includes an encoder 1 and one or more decoders 2, 3 connected by means of a communications channel 4. The communications channel 4 may be any suitable means of communicating data between computers and typically takes the form of the Internet, private network or virtual private network. However it will be appreciated that the data may be communicated using for example a removable storage device to transfer data between the computers. It will also be appreciated that the encoder and decoder may be located in the same computer such that the data may be stored securely remote from a computer and may be decoded at the same computer.

FIG. 1B shows the encoder 1 in further detail, although it will be appreciated that the decoders 2, 3 of FIG. 1 will typically have the same general structure. It can be seen that the encoder comprises a CPU 1a which is configured to read and execute instructions stored in a volatile memory 1b which takes the form of a random access memory. The volatile memory 1b stores instructions for execution by the CPU 1a and data used by those instructions. For example, in use, data such as data to be encoded and encoded output data may be stored in volatile memory 1b.

The encoder 1 further comprises non-volatile storage in the form of a hard disc drive 1c. Data such as data to be encoded and encoded output data may be stored on hard disc drive 1c. The encoder 1 further comprises an I/O interface 1d to which are connected peripheral devices used in connection with the encoder 1. More particularly, a display 1e is configured so as to display output from the encoder 1 such as the encoded output data. Input devices are also connected to the I/O interface 1d. Such input devices may include a keyboard 1f and a mouse 1g which allow user interaction with the encoder 1. It will be appreciated that the encoder may have other input interfaces such as a touch screen. A network interface 1h allows the encoder 1 to be connected to an appropriate communications network such as communications channel 4 so as to receive and transmit data from and to other computers such as decoders 2, 3. The CPU 1a, volatile memory 1b, hard disc drive 1c, I/O interface 1d, and network interface 1h, are connected together by a bus 1i. It will of course be appreciated however that the encoder and/or decoder may be implemented in any convenient way, for example as an embedded system such as an FPGA.

Referring to FIG. 2 a schematic illustration of an encoder is shown. The encoder is arranged to receive time varying input data signals s₁, . . . , sₙ 5 to be encoded and to generate output data 6 that is an encoding of the input data signals 5. The output data signals 6 are generated based upon q, q≧2, dynamical systems 7, 8, 9 each having the general form (1), in which vector-matrix notation is used with bold indicating vectors and matrices, as used consistently herein:

\dot{x}ᵢ=fᵢ(xᵢ,xⱼ|c)+\sqrt{D}ξᵢ (1)

where:
i≠jε{1, . . . , q} is the index of the dynamical system;
\dot{x}ᵢ is the time derivative of the vector xᵢ;
fᵢ(xᵢ, xⱼ|c) is a set of functions describing the dynamical system i, parameterised by the vector c; and
\sqrt{D}ξᵢ is a noise function that is assumed to be white, Gaussian and parameterised by a noise diffusion matrix as shown in (2) below. Although the noise is assumed to be white for the construction of the model used in the method, the methods described herein are still effective if the noise is not white and Gaussian.

[symbol]

ξᵢ(t)ξⱼ(τ) [symbol] =δ(t−τ)Dᵢⱼ (2)

The set of functions describing the dynamical system i, fᵢ(xᵢ, xⱼ|c), has the general form shown in (3):

\dot{p}ₖ=EFₖ(p₁, . . . ,pₘ)+CFₖ(q₁, . . . ,qₙ) (3)

where:
kε{1, . . . , l};
\dot{p}ₖ is state dimension k;
p₁, . . . , pₘ are state variables of the system;
EFₖ(p₁, . . . , pₘ) is an evolution function defining how \dot{p}ₖ evolves over time; and
CFₖ(q₁, . . . , qₙ) is a function that couples the dynamical system i to a dynamical system j having state variables q₁, . . . , qₙ, shown as 10 in FIG. 2, and includes scaling factors sₙ(t) that are time varying input signals to be encoded. That is, the data to be encoded is input as a parameter of the function CFₖ(q₁, . . . , qₙ)

In general, a single state dimension \dot{p}ₖ includes the coupling functions CFₖ(q₁, . . . , qₙ), which are a subset of the main set of functions describing dynamical system i, fᵢ(xᵢ, xⱼ|c) for iε{1, . . . , q}.

For example, two dynamical systems may be coupled. The first dynamical system may be a Lorenz system as in (4):

\dot{x}₁=10x₂−10x₁+ξ₁(t)

\dot{x}₂=28x₁−x₁x₃−x₂+s₁(t)y₂y₃+s₂(t)y₂²

\dot{x}₃=x₁x₂−2.67x₃ (4)

and the second dynamical system may be a Rossler system as in (5):

$${\dot{y}}_{1} = 2 + {y}_{1} ( {y}_{2} - 4 ) + \frac{{s}_{3} ( t ) {x}_{1}^{2}}{{x}_{3}} + \frac{{s}_{4} ( t ) {x}_{2}^{2}}{{x}_{3}} \\ {\dot{y}}_{2} = - {y}_{1} - {y}_{3} \\ {\dot{y}}_{3} = {y}_{2} + 0.45 {y}_{3} \qquad ( 5 )$$

where:
x₁, x₂, x₃ are the state variables of the first dynamical system;
y₁, y₂, y₃ are the state variables of the second dynamical system; and
s₁(t), s₂(t), s₃(t), s₄(t) are time varying input signals to be encoded.

The first and second dynamical systems of (4) and (5) can be seen to be coupled to one another by the terms s₁(t)y₂y₃, s₂(t)y₂²,

$$\frac{{s}_{3} ( t ) {x}_{1}^{2}}{{x}_{3}} and \frac{{s}_{4} ( t ) {x}_{2}^{2}}{{x}_{3}} ,$$

which are the terms that include state variables from the other system and additionally that include the time varying input signals to be encoded.

The input data 5 of FIG. 2, corresponding to s₁(t), s₂(t), s₃(t), s₄(t) of (4) and (5), are time varying signals and the output data 6 comprises a value of the state variable pₖ of each of the coupled systems 7, 8, 9, corresponding to the state variable of the function \dot{p}ₖ that includes coupling functions at each of a predetermined sample interval h, for example a sample interval that provides a frequency of 1 MHz.

As described below, a decoder is identically synchronised with a corresponding set of dynamical systems, with the identity arising from the use of a term of each of the encoder systems in the decoder system. For example, where an encoder comprises two coupled dynamical systems shown in (4) and (5), a decoder is initialised with a corresponding set of dynamical systems as shown in (6) and (7):

\dot{u}₁=10x₂−10u₁

u₂=x₂

\dot{u}₃=u₁u₂−2.67u₃+ξ₂(t) (6)

w₁=y₁

\dot{w}₂=−y₁−w₃

\dot{w}₃=w₂+0.45w₃ (7)

where:
u₁, u₂, u₃ are the state variables of the first dynamical system;
w₁, w₂, w₃ are the state variables of the second dynamical system; and
x₂ and y₁ are the state variables that are output from the encoder.

System (6) becomes a copy of system (4) via x₂ and system (7) becomes a copy of system (5) via y₁, which are the state variables output by the decoder, and which include coupling terms in the encoder.

Referring to FIG. 3, processing to generate encoded data from a plurality of input data signals is shown. At step S1 the systems 7, 8, 9 are initialised to ensure that the systems at the encoder 1 and the systems at the decoder 3 that will be used to decode the data output from the encoder 1 is the same, for example based upon a key that is available to the encoder and decoder. The values of the variables of the system do not require any initialisation because the decoder becomes synchronized with the encoder irrespective of initial values of the encoder and decoder within a short time period.

At step S2 the input signals are sampled to determine instantaneous values for each input signal at time t and at step S3 each of the systems is evaluated to determine time derivatives of the state variables, indicated as xᵢ in (1) and the state variables of each system 7, 8, 9 are updated to a value for time t+h, where h is the sample interval. In particular, given that the rate of change of each state variable for sample period h is known, the value of each state variable at the end of the time period can be determined based upon the initial value of the state variable and the change in the variable during the time period h.

At step S4 a single state variable is output for each system. The q state variables can be decoded by a corresponding decoder to determine the sampled values of the input signals at time t, as described in detail below. Whilst a greater number of state variables can be output if desired, only a single state variable is required to be output for each system. Use of a single state variable for each system to recreate the system at the decoder, and therefore decode all input data at the encoder, is possible by ensuring that a block of output values is transmitted for each set of input signal. A block of output values for each input signal can be ensured by appropriate scaling of the encoder systems. Scaling can be effected by multiplying \dot{p}ₖ for kε{1, . . . , l} by a scaling constant.

At step S5 it is determined whether more data is to be encoded. If it is determined that more data is to be encoded processing passes to step S2 where the input signals are sampled at time t+h, otherwise processing ends at step S6.

Referring to FIG. 4, a decoder 3 suitable for decoding the state variables 6 of FIG. 2 is shown. As described above, the decoder may be a computer different to the encoder 1 that encoded the data or may be the same computer as encoder 1. The decoder 3 is arranged to receive a time series of the state variables 6 output by the encoder 1 and to generate decoded data corresponding to the input signals 5. As can be seen from FIG. 4, the decoder comprises systems 7, 8, 9 and coupling functions 10 that correspond to the systems and coupling functions of the encoder 1. The decoder 3 is initialised such that the systems 7, 8, 9 in the decoder are the same as the systems 7, 8, 9 in the encoder 1. The decoder is identically synchronised with the corresponding set of dynamical systems in the encoder, with the identity arising from the use of a term of each of the encoder systems in the decoder system.

The encoder and decoder may be initialised in any convenient way, for example by hard coding the data into the encoder and decoder when the components of the transmitter and receiver are co-located in a secure environment, or by providing the data to the encoder and decoder by some other secure means. Alternatively physical parameters of the encoder and decoder may be used to define a unique fingerprint for each encoder and decoder and the fingerprint may be used to select coupling parameters and/or a model used for communications, for example based upon an embedded physical unclonable function (PUF), or randomly varying factors in production such as capacitance or resistance of physical electronic components of the encoder or decoder.

Referring to FIG. 5, processing to generate decoded data 11 based upon received state variables 6 that are output from the encoder 1 and transmitted to the decoder 3 is shown. The decoder uses time-evolving dynamical Bayesian inference using a window of time samples of size N to infer the values of the encoded signals that are used as scaling factors in the coupling functions that are used to encode the signals.

At step S10 the decoder is initialised in a corresponding manner to the initialisation of the encoder 1 at step S1 of FIG. 3, for example based upon a key that is available to the encoder and decoder. At step S11 a block of encoded data is received for processing. The block of encoded data is a time series of values for each of the state variables that is output from the encoder for each dynamical system and comprises a plurality of values for each state variable, for example the value of each state variable at each of a plurality of sample intervals in a sample time. For example 2000 values of each state variable may be processed, although it will be appreciated that a greater or smaller number of values may be received for processing.

At step S12 the data received at step S11 is used to identically synchronise the decoder systems, with the data received at step S11 providing a term of each of the decoder systems to determine a value for each state variable at each time point. At step S13 it is determined whether more data is required for Bayesian processing and if it is determined that more data is required processing returns to step S11 where further encoded data is received. Otherwise at step S14 the data generated by the repeated reconstruction of the decoder system at a plurality of time points is processed to generate an Euler discretisation vector \dot{x}ₙ=(xₙ₊₁−xₙ)/h where xₙ is a vector of time-series values for the state variables of the decoder at time n and xₙ₊₁ provides the same vector at time n+1. At step S15 the data is processed to generate a midpoint vector x_{.,n}^{*}=(xₙ₊₁+xₙ)/2.

At step S16 Bayesian processing is performed using the vectors x_{.,n}^{*} and \dot{x}ₙ together with the form of the functions ƒᵢ(xᵢ, xⱼ|c) of equation (1) that together define each of the dynamical systems, which are known from the initialisation of the decoder to determine values for s₁(t), s₂(t), s₃(t), s₄(t) in the time period associated with the time series of values. The Bayesian processing is described in detail below with reference to FIG. 6. At step S17 it is determined if further data is to be processed and if further data is to be processed processing returns to steps S11 to S13 where a further series of values of the state variables output from the encoder are received and processed. Otherwise at step S18 processing terminates.

FIG. 6 shows the Bayesian processing of step S16 of FIG. 5 in detail. As can be seen from FIG. 6 the Bayesian processing is an iterative process that repeatedly processes the data generated at steps S14 and S15 together with the known form of the functions fᵢ(xᵢ, xⱼ|c) of equation (1) to generate values for s₁(t), s₂(t), s₃(t), s₄(t). At step S20 of FIG. 6 values for the parameterisation c are initialised to zero and values of a concentration matrix Ξ are also initialised to zero. At step S21 counters k and w that provide indexes for the iterative processing of FIG. 6 are initialised to a value of 1. At step S22 a k^{th} estimate of the noise matrix Dₖ is generated according to (8):

$${D}_{k} = {\frac{h}{N} [ {\dot{x}}_{n} - {c}_{k - 1} {f}_{k - 1} ( {x}_{. , n}^{*} ) ]}^{T} [ {\dot{x}}_{n} - {c}_{k - 1} {f}_{k - 1} ( {x}_{. , n}^{*} ) ] \qquad ( 8 )$$

where:
k is an index of the iterative processing of (8) to (11);
h is the sample interval;
N is the number of samples in the window of time samples used to determine each value;
\dot{x}ₙ is the vector of time series derivatives generated at step S15 of FIG. 5;
x_{.,n}^{*} is the vector of midpoint time series generated at step S14 of FIG. 5;
fₖ₋₁ (x_{.,n}^{*}) are the functions evaluated at the midpoint time-series x_{.,n}^{*}
cₖ₋₁ is the estimate of c from the previous iteration, or the initialisation value c₀ where k=1.

At step S23 Dₖ is used to determine the k^{th} estimate of the concentration matrix Ξₖ according to (9) below.

Ξₖ=Ξₖ₋₁+hfₖ₋₁(x_{.,n}^{*})(Dₖ⁻¹)f_{w-1}(x_{.,n}^{*}) (9)

At step S24 a temporary matrix vector rₖ is determined according to (10):

$${r}_{k} = {Ξ}_{k - 1} c + {hf}_{k - 1} ( {x}_{. , n}^{*} ) ( {D}_{k}^{- 1} ) {\dot{x}}_{n} - \frac{h}{2} \frac{\partial {f}_{k} ( {x}_{. , n} )}{\partial x} \qquad ( 10 )$$

and at step S25 an updated vector cₖ is determined according to (11) below.

cₖ=Ξₖ⁻¹rₖ (11)

At step S26 it is determined whether there is convergence between the vector cₖ and the previous vector cₖ₋₁, for example by determining whether the difference between values of the vector cₖ and corresponding values of the previous vector cₖ₋₁ are all smaller than a predetermined minimum. If there is not convergence then at step S27 the counter k is incremented and processing returns to step S22. Otherwise at step S28 the vector cₖ is output. The vector cₖ provides a parameterisation of values of the dynamical systems at the encoder. As the form of the dynamical systems at the encoder other than the input values s₁(t), s₂(t), s₃(t), s₄(t) are known, including the form of the coupling functions at the encoder, the input values can be determined in a straightforward manner.

It will be appreciated that each of (8) to (11) can be evaluated in any convenient way, for example using the MATLAB® processing environment of The MathWorks, Inc or for example using an embedded system such as an FPGA. Time evolving dynamical Bayesian inference is also described in “A Tutorial on Time-Evolving Dynamical Bayesian Inference”, Stankovski, T. et. al., (arXiv:1305.0041) which is hereby incorporated by reference.

Referring now to FIG. 7, graphs 303, 304, 305, 306 illustrating input variables s₁(t), s₂(t), s₃(t), s₄(t) and graphs 301, 302 illustrating generated output variables y₁, y₂ are shown. As can be seen from graphs 303, 304, 305, 306, the input variables take the form of time varying signals. It will be appreciated that the values of each time varying signal can be used to transmit data. For example, a value of −0.3 of signal −s₃ at a time t may be used to indicate a value of 1 for a bit and a value of 0 of signal s₃ at a time t+n may be used to indicate a value of 0 for a bit. It will however be appreciated that data can be encoded in any convenient way using time varying signals.

As can be seen from graphs 301, 302, processing the input signals using the encoder causes the output variables x₂, y₁ to vary in a manner that has no identifiable correspondence with the input signals such that the input signals are encoded by the output variables in a secure manner.

In general terms communication between an encoder and decoder is subject to noise. The encoding and decoding described above uses stochastic inference that naturally decomposes the effect of noise in a communication. FIGS. 8A and 8B, illustrate the effect of noise on transmission of binary symbols using signal s₁ encoded using a Lorenz/Rossler system as illustrated above with reference to systems (4) and (5) but with a modified coupling term at the transmitter as in (12).

\dot{x}₂=28x₁−x₁x₃x₂+s₁(t)y₂y₃ (12)

Noise was added to the \dot{x}₁ and \dot{u}₃ terms of (4) and (6) respectively using the error terms ξ₁(t), ξ₂(t) to vary the signal to noise ratio (SNR). In each run 1000 randomly ordered binary symbols with values +2.5 or −2.5 were input using signal s₁ and multiple runs were performed with differing noise. The effect of the noise on the communication transfer are shown in FIG. 8A in which deviation from input values due to noise is illustrated using compact boxplots that illustrate median value with a circle, quartiles with solid boxes and maximum and minimum values with straight lines. The probability of a bit being erroneously received is shown in FIG. 8B. As can be seen from FIGS. 8A and 8B the encoding is highly resilient to noise, with a small number of errors occurring for signal to noise ratios below approximately 4 dB. Typical signal to noise ratios in a wired line are around 40 dB and around 15 dB in a wireless digital transmission communication channel and as such the encoding method described above performs well in typical transmission environments.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A method of encoding data at a computer, the computer storing data associated with a plurality of dynamical subsystems, each dynamical subsystem having a plurality of associated state variables, the plurality of dynamical subsystems being coupled by a plurality of coupling functions, the method comprising:
receiving, at the computer, data to be encoded;
inputting, at the computer, the data to be encoded into the plurality of dynamical subsystems as a plurality of parameters of the coupling functions; and
outputting, from the computer, a plurality of state variables associated with said plurality of dynamical subsystems, said plurality of state variables comprising at least one of said plurality of state variables associated with each of said dynamical subsystems, said plurality of state variables providing an encoding of said received data.

2. The method of claim 1, wherein at least one of said plurality of dynamical systems is a self-sustaining oscillating system.

3. The method of claim 1, wherein at least one of said plurality of dynamical systems is a chaotic system.

4. The method of claim 1, wherein at least one of said plurality of dynamical systems is a system selected from the group consisting of: a Lorenz system; and a Rossler system.

5. (canceled)

6. The method of claim 1, wherein the output plurality of state variables comprises a single state variable for each dynamical subsystem.

7. The method of claim 1, wherein a first coupling function of said plurality of coupling functions forms a part of a first dynamical subsystem of said plurality of dynamical subsystems and said first coupling function comprises at least one state variable of a second of said plurality of dynamical subsystems.

8. The method of claim 1, further comprising processing the plurality of dynamical systems to determine time derivatives of each of said plurality of state variables associated with each of said plurality of dynamical subsystems.

9. The method of claim 1, wherein outputting a plurality of state variables associated with said plurality of dynamical subsystems comprises outputting a plurality of values for each of said output state variables.

10. (canceled)

11. A computer apparatus for encoding data, the apparatus comprising:
a memory storing data associated with a plurality of dynamical subsystems, each dynamical subsystem having a plurality of associated state variables, the plurality of dynamical subsystems being coupled by a plurality of coupling functions and processor readable instructions; and
a processor arranged to read and execute instructions stored in said memory; wherein said processor readable instructions comprise instructions arranged to control the computer to perform the method of claim 1.

12. A method of decoding data at a computer, the computer storing data associated with a plurality of dynamical subsystems, each dynamical subsystem having a plurality of associated state variables, the method comprising:
receiving, at the computer from an encoder, data associated with a plurality of encoder state variables, the encoder state variables being associated with a plurality of dynamical subsystems at the encoder used to encode said data to be decoded, the plurality of dynamical subsystems at the encoder being coupled by a plurality of coupling functions; and
inputting, at the computer, said plurality of encoder state variables as parameters of said plurality of dynamical subsystems to determine values for each of the plurality of state variables associated with the plurality of dynamical subsystems; processing, by the computer, said determined values to generate said data to be decoded.

13. The method of claim 12, wherein processing the determined values to generate said data to be decoded comprises performing dynamical Bayesian inference on said determined values.

14. The method of claim 13, wherein performing dynamical Bayesian inference on said determined values comprises:
iteratively processing, by the computer, said determined values based upon said plurality of dynamical subsystems.

15. The method of claim 13, wherein performing dynamical Bayesian inference on said determined values comprises:
generating, at the computer, an Euler discretisation vector from said determined values;
generating, at the computer, a midpoint time series vector from said determined values; and
processing, by the computer, said Euler discretisation vector and said midpoint time series vector to generate said data to be decoded.

16. The method of claim 15, wherein processing said Euler discretisation vector and said midpoint time series vector comprises:
iteratively processing, by the computer, the Euler discretisation vector and the midpoint time series vector to determine an estimate of a parameterisation of each dynamical subsystem to generate said data to be decoded.

17. The method of claim 12, wherein said data associated with a plurality of dynamical subsystems comprises data associated with the plurality of dynamical subsystems at the encoder.

18. The method of claim 17, wherein said data associated with a plurality of dynamical subsystems further comprises data associated with said plurality of coupling functions.

19. (canceled)

20. The method of claim 12, wherein at least one of said plurality of dynamical systems is a self-sustaining oscillating system.

21. The method of claim 12, wherein at least one of said plurality of dynamical systems is a chaotic system.

22. The method of claim 12, wherein at least one of said plurality of dynamical systems is system selected from the group consisting of: a Lorenz system; and a Rossler system.

23. The method of claim 12, wherein the data associated with a plurality of encoder state variables comprises a single state variable for each dynamical subsystem at the encoder at each of a plurality of time points.

24. (canceled)

25. (canceled)
